(19) United States
(12) Patent Application Publication
(10) Pub. No.: US 2008/0074244 A1
(43) Pub. Date: Mar. 27, 2008

(54) Burglarproof device

(75) Inventor: Tsun-Huang Lin, Sijhih City (TW)

Correspondence Address: Troxell Law Office Pllc, Suite 1404, 5205 Leesburg Pike, Falls Church, VA, 22041, US

(73) Assignee: Quitewin Technology Corporation

(21) Appl. No.: 11/526,230

(22) Filed: Sep. 25, 2006

(51) Int. Cl. B60R 25/10

(52) U.S. Cl. 340/426.1

(57) ABSTRACT

A burglarproof device is constituted by a control element, a switching element, a battery element, an electric energy transformation device, load equipment, and a charging device. When the burglarproof device is used, a supply-voltage and supply-current of the battery element is transformed into a low voltage and low current by the electric energy transformation device and through an action of the control element, such that a low voltage and low current equipment of the load equipment can continue to maintain at an original function.

### BACKGROUND OF THE INVENTION

a) Field of the Invention

The present invention relates to a burglarproof device, and more particularly to a burglarproof device which transforms a supply-voltage and supply-current of a battery element into a low voltage and low current by an electric energy transformation device and through an action of a control element.

b) Description of the Prior Art

A conventional car-use burglarproof device turns off a battery power through a controller, enabling its equipment to be unavailable to use, to achieve the burglarproof function. However, as a low voltage and low current is not kept to provide a low voltage and low current equipment of load equipment, memory data of the low voltage and low current equipment of load equipment are lost.

Therefore, how to eliminate the aforementioned problem is a technical issue to be solved by the present inventor.

### SUMMARY OF THE INVENTION

The primary object of present invention is to provide a burglarproof device which transforms a supply-voltage and supply-current of a battery element into a low voltage and low current by an electric energy transformation device and through an action of a control element, such that a low voltage and low current equipment of load equipment can continue to maintain at an original function.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows a schematic view of an embodiment of the present invention.

FIG. 3 shows a second schematic view of an embodiment of the present invention.

FIG. 4 shows a third schematic view of an embodiment of the present invention.

FIG. 5 shows a fourth schematic view of an embodiment of the present invention.

### DETAILED DESCRIPTION OF THE PREFERRED EMBODIMENTS

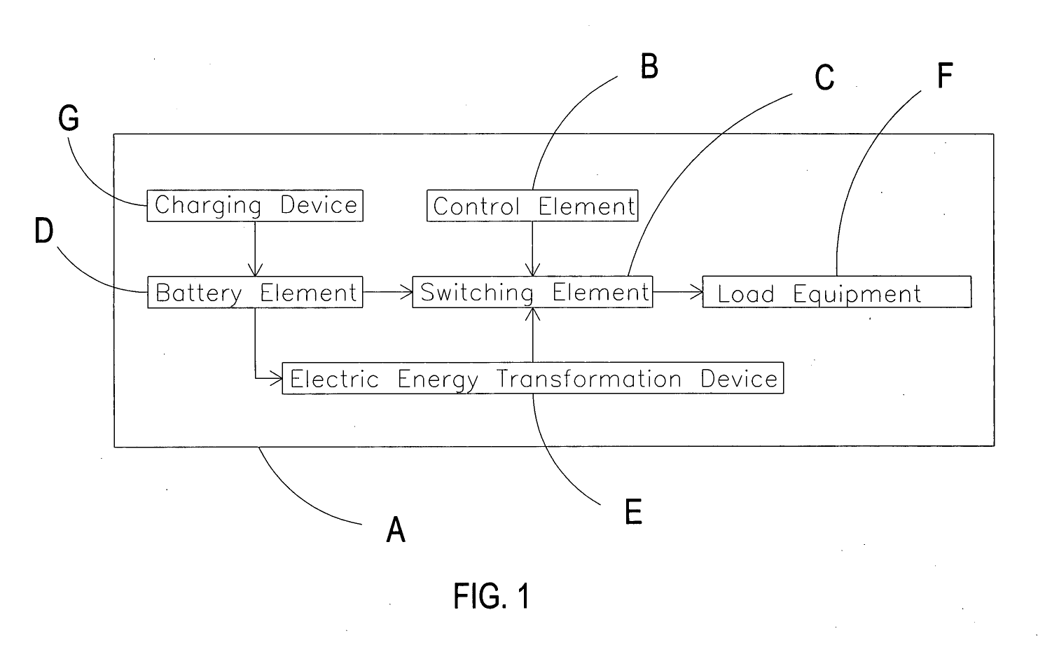

Referring to FIG. 1, a burglarproof device A of the present invention comprises a control element B, a switching element C, a battery element D, an electric energy transformation device E, a load equipment F, and a charging device G, wherein the control element B includes a manual switch B1 and a remote control B2, so as to turn on and off a burglarproof function of the burglarproof device A; the switching element C can be used to quickly and safely switch to the burglarproof function of burglarproof device A; the battery element D is used to provide energy source to be used by the burglarproof device A; the electric energy transformation device E includes an electric energy transformation circuit E1, an electric energy detection circuit E2, and an electric energy protection circuit E3, so as to transform a supply-voltage and supply-current of the battery element D into a low voltage and low current; and the load equipment F is connected to the battery element D which is charged by the charging device G.

When the control element B is acting, the burglarproof function of burglarproof device A can be quickly and safely activated by a switching of the switching element C, and the supply-voltage and supply-current of battery element D can be transformed into the low voltage and low current through the electric energy transformation device E, such that a low voltage and low current equipment of the load equipment F can continue to maintain at an original function.

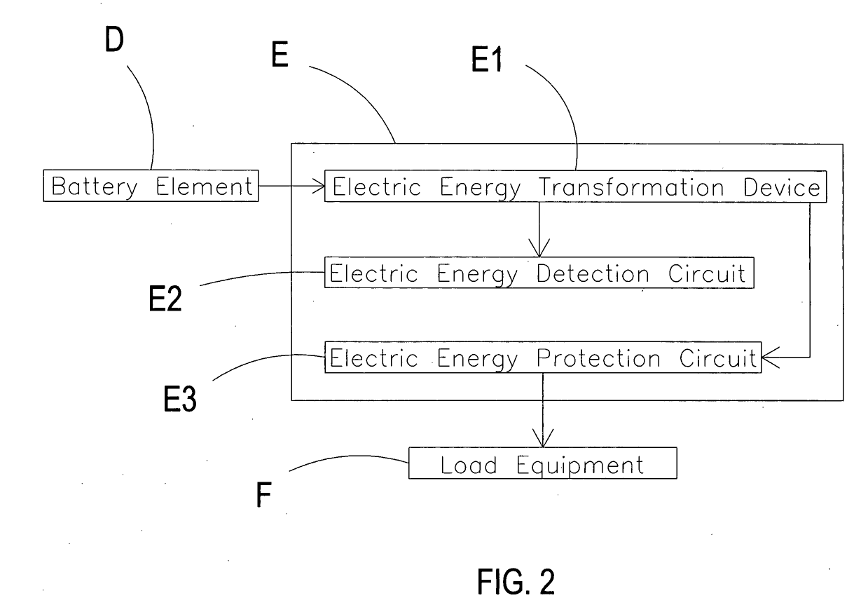

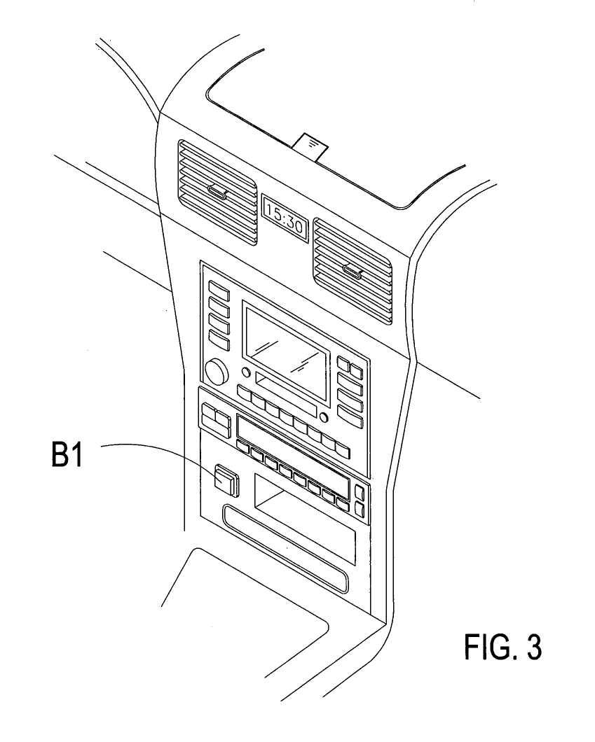

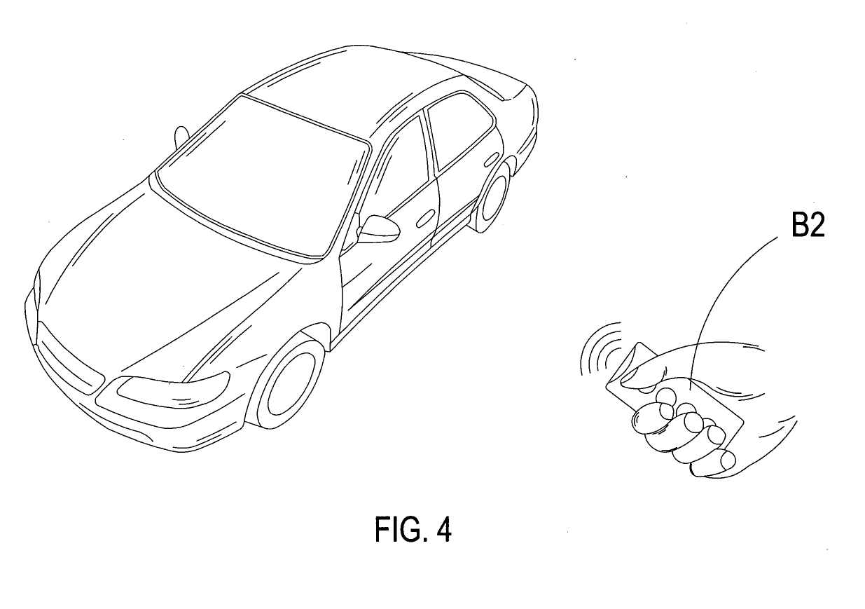

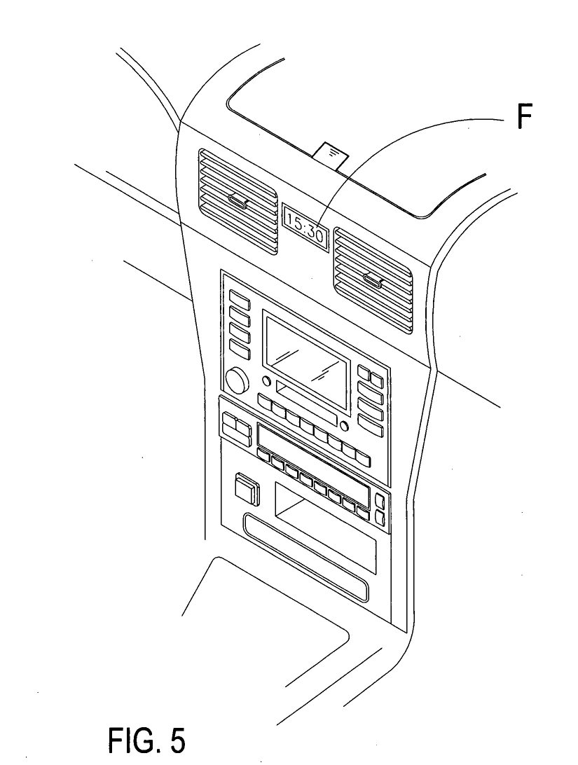

Referring to FIGS. 2 to 6, a burglarproof device A of the present invention comprises a control element B, a switching element C, a battery element D, an electric energy transformation device E, a load equipment F, and a charging device G, wherein the control element B includes a manual switch B1 and a remote control B2, so as to turn on and off a burglarproof function of the burglarproof device A; the switching element C is for switching to the burglarproof device A, so as to quickly and safely switch to the burglarproof function of burglarproof device A; the battery element D provides energy source to be used by the burglarproof device A, and can be charged by the corresponding charging device G; the electric energy transformation device E includes an electric energy transformation circuit E1, an electric energy detection circuit E2, and an electric energy protection circuit E3, so as to transform a supply-voltage and supply-current of the battery element D into a low voltage and low current; and the load equipment F is connected to the battery element D, and a low voltage and low current equipment of the load equipment F can continue to maintain at an original function through the low voltage of low current outputted by the electric energy transformation device E.

When the burglarproof device A is to be turned on, it can be activated by the manual switch B1 or the remote control B2, so as to quickly and safely switch to the burglarproof function of the burglarproof device A through the switching element C. In a same time, the supply-voltage and supply-current of battery element D are transformed into the low voltage and low current, through the electric energy transformation circuit E1, the electric energy detection circuit E2, and the electric energy protection circuit E3 of the electric energy transformation device E, such that the low voltage and low current equipment of load equipment F can continue to maintain at the original function.

To further manifest the advancement and practicability of the present invention, the present invention is compared with a conventional burglarproof device as follow:

Shortcomings of a conventional burglarproof device
1. It is not provided with the electric energy transformation device.
2. According to item 1, the configuration data of load equipment is easily lost.
3. According to item 2, the data of load equipment needs to be re-configured.
4. It is not provided with the convenience and practicability of usage.

Advantages of the present invention
1. It is provided with the electric energy transformation device.
2. According to item 1, the configuration data of load equipment can be kept continuously.
3. According to item 2, the data of load equipment does not need to be re-configured.
4. It is provided with the convenience in usage.
5. It has the advancement and practicability.
6. It can improve an industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A burglarproof device comprising a control element, a switching element, a battery element, an electric energy transformation device, a load equipment, and a charging device; in using the burglarproof device, a supply-voltage and supply-current of the battery element being transformed into a low voltage and low current by the electric energy transformation device and through an action of the control element, such that a low voltage and low current equipment of the load equipment continues to maintain at an original function.

2. The burglarproof device according to claim 1, wherein the control element further uses a RFID (Radio Frequency Identification Device) to turn on and off a burglarproof function of the burglarproof device.

3. The burglarproof device according to claim 1, wherein the switching element further uses a high quality and large current solenoid valve, an electromagnetic relay, and a semiconductor switch as an element for quickly and safely switching to the burglarproof device.

4. The burglarproof device according to claim 1, wherein the battery element further uses a nickel-metal-hydride battery, a nickel-cadmium battery, a lithium-ion battery, and other related battery element which provides energy source to the burglarproof device and equipment.

5. The burglarproof device according to claim 1, wherein the charging device further users a generator, a voltage regulator, and other related charging device which charges the battery element.

6. The burglarproof device according to claim 1, wherein the burglarproof device is further in collaboration with a car-use sensor to turn on the burglarproof function.

7. The burglarproof device according to claim 6, wherein the car-use sensor which is used in collaboration with the burglarproof device includes a door switch, a vibration switch, an inching switch, a ultrasonic wave sensor, an infrared sensor, and other related car-use sensor which senses intruding signals.
